(19) United States
(12) Patent Application Publication
(10) Pub. No.: US 2015/0324305 A1
(43) Pub. Date: Nov. 12, 2015

(54) CHANGE MANAGEMENT SYSTEM, CHANGE MANAGEMENT METHOD, AND CHANGE MANAGEMENT PROGRAM

(71) Applicants: NEC CORPORATION, Tokyo (JP); VANDERBILT UNIVERSITY, Nashville, TN (US)

(72) Inventors: Takayuki KURODA, Tokyo (JP); Aniruddha Suresh GOKHALE, Nashville, TN (US)

(73) Assignees: VANDERBILT UNIVERSITY, Nashville, TN (US); NEC CORPORATION, Tokyo (JP)

(21) Appl. No.: 14/471,858

(22) Filed: Aug. 28, 2014

Related U.S. Application Data
(60) Provisional application No. 61/991,075, filed on May 9, 2014.

(51) Int. Cl. G06F 13/12; G06F 13/40

(52) U.S. Cl. CPC G06F 13/126; G06F 13/4068

(57) ABSTRACT

A change management system includes a system definition expansion unit 11 which generates information of a state machine set made up of one or more state machines, from a system definition. The system definition includes one or more primitives and any number of wirings. Each of the primitives includes any number of wire ports. Each of the wire ports includes one state machine. Each of the wirings connects to two wire ports included in different primitives. The system definition expansion unit 11 generates the information of the state machine set, by connecting existing definitions of the primitives by the wirings.

This application is based upon and claims the benefit of priority from U.S. provisional application No. 61/991,075, filed on May 9, 2014, the disclosure of which is incorporated here in its entirety by reference.

### TECHNICAL FIELD

The present invention relates to a change management system, a change management method, and a change management program.

### BACKGROUND ART

Change management is intended to, upon changing a system, reduce the work of the manager and the change operator of the system to be changed and the influence on the users of the system to be changed. For example, in the case where the system to be changed is a complex system made up of a plurality of components, the change operation is complex. The complex change operation increases the work of the operator and the manager who supervises the operation by the operator. This affects the users of the system more significantly.

Particularly in the case where the components constituting the system have dependence relationships, the change operation tends to be complex because the order in which the components undergo the change operation is critical. Suppose the system includes a component A and a component B. The dependence between the components is the relationship between two elements such that, for the component A to function properly, the component B needs to function properly.

The component A depends on the component B in the above-mentioned example. Operations to construct the system including the component A and the component B need to be ordered so that the component B is constructed first and the component A is constructed next.

A change management system is a system that automatically generates an operation plan necessary to change the system while taking such dependence into consideration. Note that a change management system in the present invention is a system that derives necessary operations and an appropriate operation procedure from input data that includes: the current state of each component; and the desired state of each component after the change. In the change management system, information about the dependence between the components and information about the operations for the components are defined beforehand.

With use of the above-mentioned change management system, the manager can efficiently generate the operation procedure effective in carrying out the complex change operation, and the operator can efficiently carry out the operation on the basis of the generated effective operation procedure. This is expected to reduce the influence on the users of the system to be changed.

A number of studies and products related to such a change management system are already known. Non Patent Literature (NPL) 1 describes a method of defining a system to be managed as multiple state machine sets. According to the method described in NPL 1, a transition condition of a transition in each state machine set is described using a state in a state machine other than the state machine including the transition.

A state machine represents a component included in the system. The state of the state machine represents a possible state of the component. A transition includes information of an operation when changing the state of the component. A transition condition represents the dependence of the operation corresponding to the information included in the transition.

A change plan based on the system definition method described above is expected to be more effective than change plans based on other methods, because a wide range of situations can be planned and definitions are reusable. The present invention is intended for a system based on this definition method. The intended system is hereafter simply referred to as “change management system”.

To compute the operation procedure using the above-mentioned state machine set, first the current state is set in all state machines and the desired state is set in at least one of the state machines. The operation procedure is computed by determining, from the state machine set in which the current state and the desired state are set, the transition order for enabling all state machines in which the desired state is designated to transition from the current state to the desired state while satisfying their transition conditions. The change plan is generated in this way. NPL 1 describes an example of the operation procedure computation method.

### CITATION LIST

### Non Patent Literature(s)

NPL 1: S. Hagen and A. Kemper, “Model-based planning for state-related changes to infrastructure and software as a service instances in large data centers,” in Cloud Computing (CLOUD), 2010 IEEE 3rd International Conference on July 2010, pp. 11-18.

### SUMMARY

An exemplary object of the present invention is to provide a change management system, a change management method, and a change management program that can efficiently generate information of a number of state machine sets from a system definition including state machines.

A change management system according to the present invention is a change management system including a system definition expansion unit which generates information of a state machine set made up of one or more state machines, from a system definition, wherein the system definition includes one or more primitives and any number of wirings, wherein each of the primitives includes any number of wire ports, wherein each of the wire ports includes one state machine, wherein each of the wirings connects to two wire ports included in different primitives, and wherein the system definition expansion unit generates the information of the state machine set, by connecting existing definitions of the primitives by the wirings.

A change management method according to the present invention is a change management method executed in a change management system for generating, from a system definition, information of a state machine set made up of one or more state machines, wherein the system definition includes one or more primitives and any number of wirings, wherein each of the primitives includes any number of wire ports, wherein each of the wire ports includes one state machine, wherein each of the wirings connects to two wire ports included in different primitives, and wherein the information of the state machine set is generated by connecting existing definitions of the primitives by the wirings.

A non-transitory computer-readable recording medium having recorded therein a change management program according to the present invention is a non-transitory computer-readable recording medium having recorded therein a change management program that, when executed by a computer, generates information of a state machine set made up of one or more state machines, from a system definition, wherein the system definition includes one or more primitives and any number of wirings, wherein each of the primitives includes any number of wire ports, wherein each of the wire ports includes one state machine, wherein each of the wirings connects to two wire ports included in different primitives, and wherein the information of the state machine set is generated by connecting existing definitions of the primitives by the wirings.

### BRIEF DESCRIPTION OF THE DRAWINGS

FIG. 1 It is a block diagram depicting a structural example of Exemplary Embodiment 1 of a change management system according to the present invention.

FIG. 2 It is an explanatory diagram depicting the concept of a state machine set.

FIG. 3 It is an explanatory diagram depicting an example of a textual definition of a state machine set.

FIG. 4 It is an explanatory diagram depicting an example of a transition order derivation result.

FIG. 5A It is an explanatory diagram depicting an example of primitives.

FIG. 5B It is an explanatory diagram depicting another example of primitives.

FIG. 6 It is an explanatory diagram depicting an example of a textual definition of a primitive.

FIG. 7 It is an explanatory diagram depicting an example of a textual definition of a wire interface.

FIG. 8 It is an explanatory diagram depicting an example of connected primitives.

FIG. 9 It is an explanatory diagram depicting an example of a state machine set expanded from connected primitives.

FIG. 10 It is an explanatory diagram depicting an example of a system change plan generation result.

FIG. 11 It is an explanatory diagram depicting an example of a composite.

FIG. 12 It is an explanatory diagram depicting an example of a textual definition of a composite.

FIG. 13 It is an explanatory diagram depicting an example of a system definition made up of primitives and a composite.

FIG. 14 It is an explanatory diagram depicting another example of primitives.

FIG. 15 It is an explanatory diagram depicting an example of primitives expanded from a composite.

FIG. 16 It is an explanatory diagram depicting an example of a state machine set of a system definition expanded from primitives.

FIG. 17 It is a flowchart depicting operation of a system definition expansion process by a change management system 100.

FIG. 18 It is a flowchart depicting operation of a composite expansion process by the change management system 100.

FIG. 19 It is a block diagram depicting a structural example of Exemplary Embodiment 2 of a change management system according to the present invention.

FIG. 20A It is an explanatory diagram depicting an example of a current system definition.

FIG. 20B It is an explanatory diagram depicting an example of a new system definition.

FIG. 21 It is an explanatory diagram depicting another example of primitives.

FIG. 22 It is an explanatory diagram depicting an example of a system difference definition generated from two system definitions.

FIG. 23 It is an explanatory diagram depicting an example of a state machine set expanded from a system difference definition.

FIG. 24 It is a flowchart depicting operation of a system difference definition generation process and expansion process by the change management system 100.

FIG. 25 It is a flowchart depicting operation of a system difference definition generation process by the change management system 100.

FIG. 26 It is a flowchart depicting operation of a system difference definition expansion process by the change management system 100.

FIG. 27 It is a block diagram schematically depicting a change management system according to the present invention.

### DESCRIPTION OF EXEMPLARY EMBODIMENT

### Exemplary Embodiment 1

[Structure]

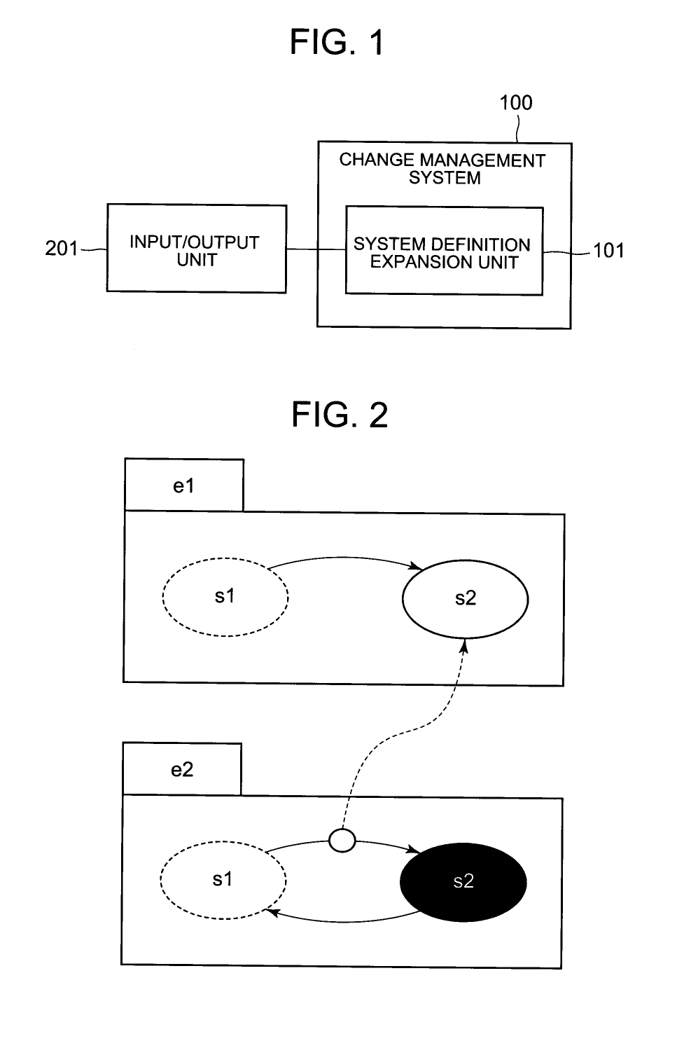

The following describes Exemplary Embodiment 1 of the present invention, with reference to drawings. FIG. 1 is a block diagram depicting a structural example of Exemplary Embodiment 1 of a change management system according to the present invention. A change management system 100 depicted in FIG. 1 includes a system definition expansion unit 101.

The system definition expansion unit 101 has a function of expanding a system definition into a state machine set made up of one or more state machines. The system definition expansion unit 101 is connected with an external input/output unit 201 via a communication network or the like so as to communicate with the input/output unit 201.

The system definition is input to the input/output unit 201. The system definition expansion unit 101 receives the input system definition via the input/output unit 201. The system definition expansion unit 101 converts the received system definition into the state machine set, and transmits the state machine set to the input/output unit 201. The input/output unit 201 outputs the transmitted state machine set.

The state machine set in this exemplary embodiment indicates a system to be managed and a change request for the system to be managed. The state machine set is made up of one or more state machines. Each state machine represents a component included in the system.

The state machine includes a plurality of states. A state includes a transition to another state in the same state machine. The state machine always includes one current state and any number of desired states. In the case where a plurality of desired states are designated, the desired state of the state machine may be any of the designated states. In the case where no desired state is designated, the desired state of the state machine may be any state. A transition condition of a transition is designated according to a state in a state machine other than a state machine including the transition.

FIG. 2 is an explanatory diagram depicting the concept of a state machine set. In FIG. 2, the rectangles each represent a state machine. The ellipses each represent a state. The solid arrows each represent a transition. The dotted arrow represents a transition condition. The dotted ellipses each represent a current state. The black ellipse represents a desired state. The circle on the arrow of the transition represents the start point of the arrow of the transition condition. State machines and the like in other drawings are represented in the same way as in FIG. 2.

FIG. 2 depicts a state machine set made up of two state machines “e1” and “e2”. Each of “e1” and “e2” includes two states “s1” and “s2”.

As depicted in FIG. 2, “s1” in “e1” includes a transition to “s2”. Each of “s1” and “s2” in “e2” includes a transition to the other state. The transition from “s1” to “s2” in “e2” has the state “s2” of “e1” as a transition condition. Moreover, “e1” has “s1” as a current state, and “e2” has “s1” as a current state and “s2” as a desired state.

For example, the state “s1” of the state machine “e1” is hereafter denoted by “e1(s1)”, and the transition of the state machine “e1” from the state “s1” to the state “s2” is hereafter denoted by “e1(s1,s2)”, for sake of simplicity.

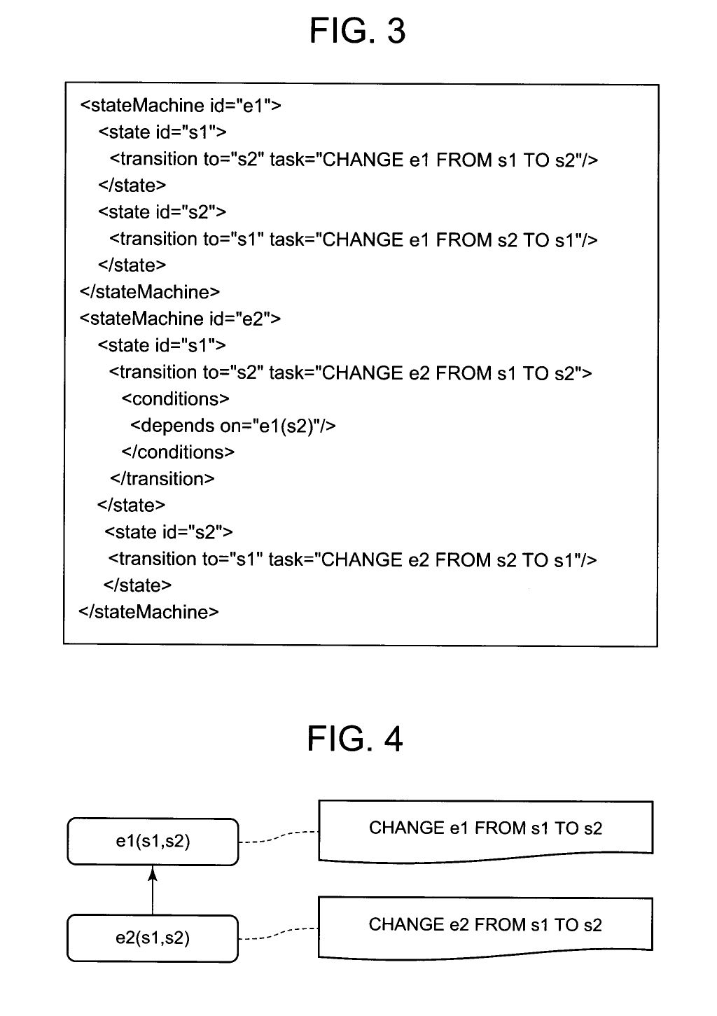

FIG. 3 is an explanatory diagram depicting an example of a textual definition of a state machine set. FIG. 3 depicts an example of the definition of the state machine set depicted in FIG. 2, as an example of representation using Extensible Markup Language (XML).

As depicted in FIG. 3, for example, each state machine is represented by a “stateMachine” tag. The ID of the state machine is represented by an “id” attribute of “stateMachine”. Each state of the state machine is represented by a “state” tag as a child element of the “stateMachine” tag. The ID of the state is represented by an “id” attribute of “state”.

As depicted in FIG. 3, the transition of the state is represented by a “transition” tag as a child element of the “state” tag. The ID indicating the state of the transition destination is represented by a “to” attribute of “transition”. The system change task executed for the transition is represented by a “task” attribute of the “transition” tag.

As depicted in FIG. 3, the transition condition of the transition is represented by a “conditions” tag as a child element of the “transition” tag. In the case where the transition has the state “s2” of the state machine “e1” as the transition condition, the transition condition is represented by describing a “depends” tag as a child element of the “conditions” tag and setting the “on” attribute of “depends” tag to “e1(s2)”. In the case where one transition has a plurality of transition conditions, the plurality of transition conditions are described using a plurality of “depends” tags as child elements of the “conditions” tag.

The system change task is, for example, described as a program in the case where the system change task is executed by a computer, and described in a natural language in the case where the system change task is executed by a human operator.

In the example depicted in FIG. 3, the system change task is described in a natural language, on the assumption that the system change task is executed by a human operator. Instead of directly writing the task description in the “task” attribute, a reference pointer to an external file in which the system change task is written may be written in the “task” attribute. Besides, the detailed description of the system change task may be given instead of the description of about one line as depicted in FIG. 3.

A system change plan based on the above-mentioned state machine set can be generated by finding such transition order that enables all state machines in which the desired state is designated to transition from the current state to the desired state while constantly satisfying all transition conditions. In the example of the state machine set depicted in FIG. 2, the transition order “(e1(s1,s2), e2(s1,s2))” is the simplest single solution.

FIG. 4 is an explanatory diagram depicting an example of a transition order derivation result. In FIG. 4, the rounded-corner rectangles on the left each represent a transition. The arrow between the transitions represents the dependence between the transitions. In other words, the arrow between the transitions indicates the relationship that “e2(s1,s2)” is performed only after “e1(s1,s2)” is performed.

In FIG. 4, the curved-bottom blocks connected with the respective transitions by dotted lines each represent a system change task associated with the transition. The system change plan is properly executed by executing the system change tasks in the order in which the transitions are performed.

The following describes a system definition in this exemplary embodiment. In this exemplary embodiment, a state machine set is expressed by a predetermined structure, thus enabling a state machine set indicating a larger and more complex system to be defined concisely. The system definition expansion unit 101 converts the system definition into the state machine set.

In this exemplary embodiment, the system definition is represented by a set of components which are the concept indicating a component included in the system. Each component includes a portion of the definition of the state machine set constituting the system.

Component types include a primitive and a composite. The primitive represents a specific component included in the system. The composite represents a structure in which components are combined. The composite includes a plurality of composites or primitives. The use of the composite enables a larger and more complex component to be defined concisely. Note that the composite is fully resolved into primitives before the conversion to the state machine set.

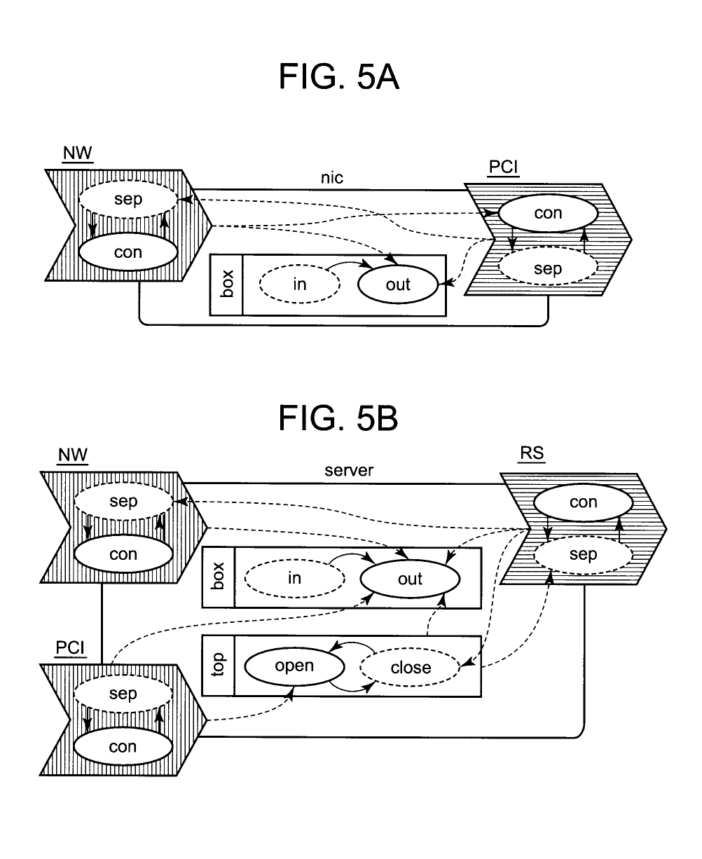

FIG. 5A and FIG. 5B are explanatory diagrams depicting examples of primitives. FIG. 5A depicts an example of a primitive “nic” which is a network interface card. FIG. 5B depicts an example of a primitive “server” which is a physical server machine.

Each primitive mainly includes two types of state machines, namely, a part and a wire port. The part represents an individually changeable state machine included in the primitive. The wire port represents a state machine used when the primitive is connected to another primitive. The part and the wire port have their own states, and so are represented as independent state machines. A transition condition is freely set between state machines in the same primitive.

In this exemplary embodiment, the wire port has two types: an accept and a consume. The accept has a function of accepting a connection from a consume included in another primitive. The consume has a function of connecting to an accept included in another primitive. In FIG. 5A and FIG. 5B, the accept is indicated by the vertical line pattern, and the consume is indicated by the horizontal line pattern. The accept and the consume are represented in the same way in other drawings.

Two primitives are connected by a consume included in one primitive connecting to an accept included in the other primitive. Here, the connected consume and accept need to be connection portions conforming to a specific standard. The concept indicating the specific standard is referred to as “wire interface” in this exemplary embodiment.

In FIG. 5B, “server” includes a consume, two accepts, “box” which is a part, and “top” which is a part.

The underlined letters near each wire port depicted in FIG. 5 correspond to the wire interface which the wire port conforms to. For example, in FIG. 5B, the consume conforms to the wire interface “RS”, the upper accept conforms to the wire interface “NW”, and the lower accept conforms to the wire interface “PCI”. The wire interfaces are represented in the same way in other drawings.

Here, “RS” is a wire interface relating to installation in a server rack, “NW” is a wire interface relating to a network cable, and “PCI” is a wire interface relating to PCIExpress.

In each wire port, “sep” indicates that the wire port is disconnected (separate), and “con” indicates that the wire port is connected (connect).

Moreover, “box” is a part indicating whether or not “server” is in a box, where “box(out)” indicates that “server” is not in the box, and “box(in)” indicates that “server” is in the box.

Meanwhile, “top” is a part relating to the lid of the enclosure of “server”, where “top(open)” indicates that the lid of “server” is open, and “top(close)” indicates that the lid of “server” is closed.

All state machines other than “box” designate “box(out)” as a transition condition. This is because the operator cannot perform any operation in the case where “server” is in the box.

The consume conforming to “RS” designates “top(close)” as a transition condition. This is because the lid of the enclosure needs to be closed when “server” is installed in or removed from the rack. Meanwhile, “top” designates “RS(sep)” as a transition condition. This is because “server” needs to be separated from the rack when the lid is opened or closed.

The consume conforming to “RS” designates “NW(sep)” as a transition condition. This is because the network cable needs to be connected after “server” is installed in the rack and disconnected before “server” is removed from the rack.

The accept conforming to “PCI” designates “top(open)” as a transition condition. This is because the lid of the enclosure needs to be open when a component is inserted to or removed from a PCIExpress slot.

FIG. 5A and FIG. 5B depict arrows respectively. Each arrow corresponds to a transition condition from a state machine itself to a state in another state machine, unlike FIG. 2. The arrow indicates that all transitions in the state machine have the same transition condition as that designated by the arrow. The same depiction is used in other drawings.

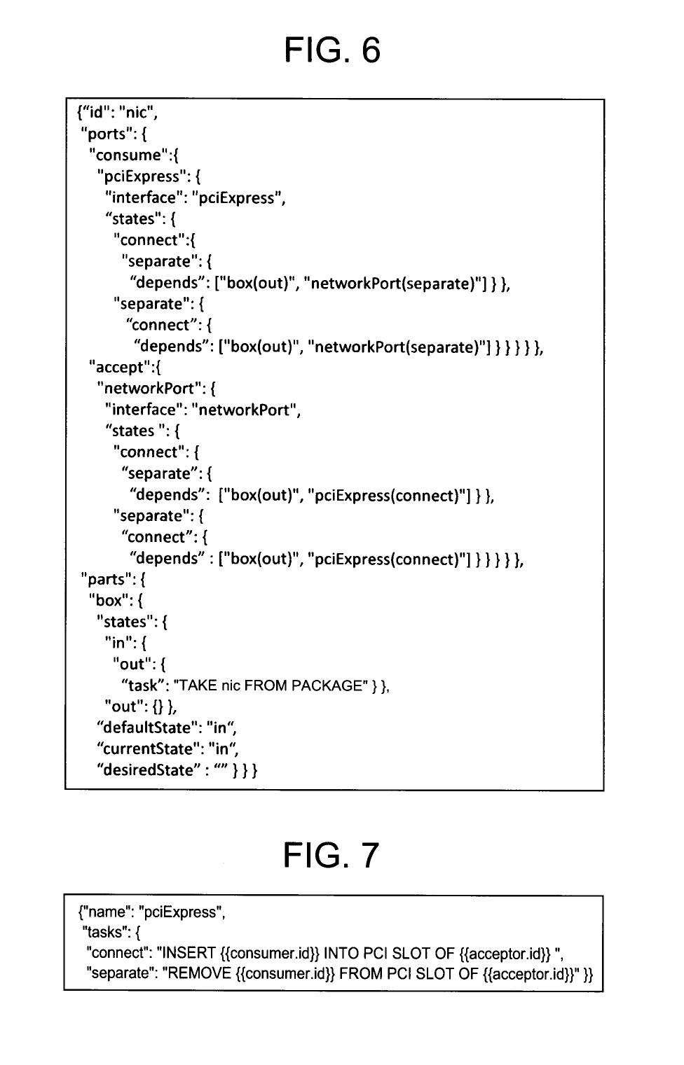

FIG. 6 is an explanatory diagram depicting an example of a textual definition of a primitive. FIG. 6 depicts an example of textually defining the primitive “nic” depicted in FIG. 5A, as an example of representation using JavaScript® Object Notation (JSON). The definition depicted in FIG. 6 has an id element indicating the ID of the primitive, a ports element indicating a wire port, and a parts element indicating a part. The ports element has a consume element and an accept element.

In detail, “nic” has “nic” as an id element, “pciExpress” as a consume element, “networkPort” as an accept element, and “box” as a parts element. Each element in ports has an interface element indicating a wire interface and a states element indicating a state list.

Moreover, “pciExpress” has “pciExpress” as an interface element, and “connect” and “separate” as a states element.

Each element in states indicates a state of a state machine. Each element in states has a list of other states to which a transition can be made, and a “depends” element indicating a transition condition when a transition is made to the corresponding state.

The state “connect” of “pciExpress” has a transition to “separate”. Likewise, the state “separate” of “pciExpress” has a transition to “connect”. Each transition has “box(out)” and “networkPort(separate)” as a depends element.

As can be seen in “networkPort” which is an accept element depicted in FIG. 5A, the wire port has the same structure of states and transitions as “pciExpress”. As depicted in FIG. 6, however, “box(out)” and “pciExpress(connect)” are designated in the depends element in “networkPort”.

Each element in parts has a states element indicating a state list, a currentState element indicating a current state, and a desiredState element indicating a desired state. A transition of an element indicating a state in parts has a task element indicating a system change task.

The parts element “box” has two states “in” and “out”. A transition from “in” to “out” has a system change task “take nic from package” as a task element. Since there is no transition from the state “out”, nothing is written in an element “out”.

The parts element “box” has “in” as the currentState element indicating the current state, and has nothing as the desiredState element indicating the desired state. Some value always needs to be set for the current state in the primitive. Accordingly, an initial state may be set so as to be used in the case where the current state is not set to any value. In the example of “box” depicted in FIG. 6, “in” is set as a defaultState element. For example, the initial state is set on the basis of an initial state when the primitive is shipped from the seller.

As depicted in FIG. 6, the transition in each element in ports has no system change task, because the system change task is defined by the wire interface.

FIG. 7 is an explanatory diagram depicting an example of a textual definition of a wire interface. In the example depicted in FIG. 7, the wire interface has only a name element and a tasks element. The tasks element has only a connect element and a separate element. The connect element indicates a system change task when a component is connected to the wire interface. The separate element indicates a system change task when a component is removed from the wire interface.

FIG. 7 depicts an example of the definition of the wire interface of PCIExpress. The name element indicates “pciExpress”. The connect element in tasks indicates “insert {{consumerId}} into PCI slot of {{acceptorId}}”. The separate element in tasks indicates “remove {{consumerId}} from PCI slot of {{acceptorId}}”.

Each system change task may be described as a template. In the above-mentioned example, “{{consumer.id}}” and the like are replaced with appropriate values in the system definition expansion process. For example, in the case where the consume of “nic” and the accept of “server” are connected via the wire interface “pciExpress”, the system change task of the connect element mentioned above is converted to “insert nic into PCI slot of server”.

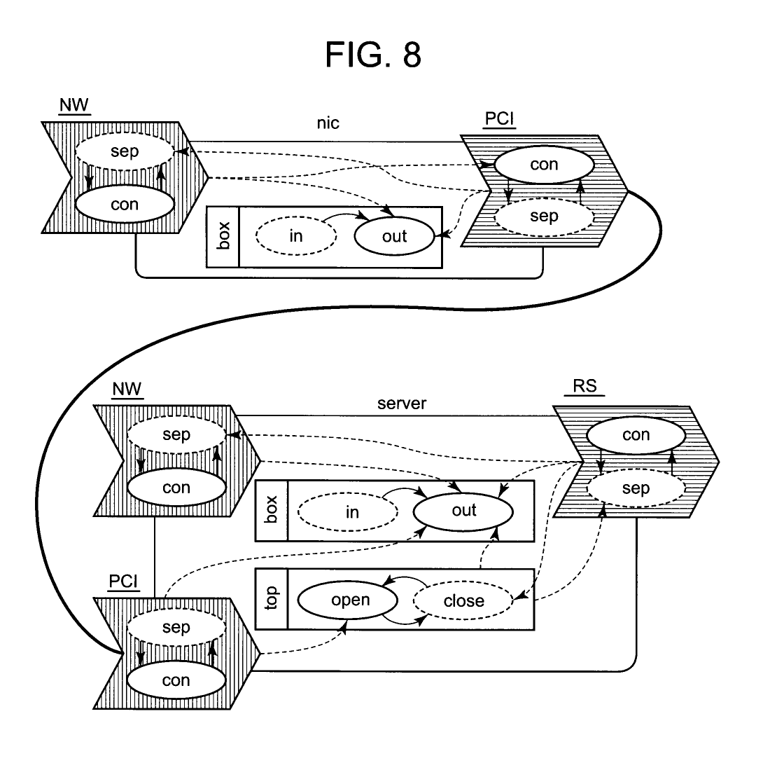

FIG. 8 is an explanatory diagram depicting an example of connected primitives. FIG. 8 depicts a situation where the primitive “server” and the primitive “nic” are connected via the wire ports conforming to the wire interface “PCI”. The concept of connecting two wire ports is referred to as “wiring” in this exemplary embodiment. In FIG. 8, the thick curve represents the wiring. The definition relating to primitive connection using a wiring will be described later in the description of a composite.

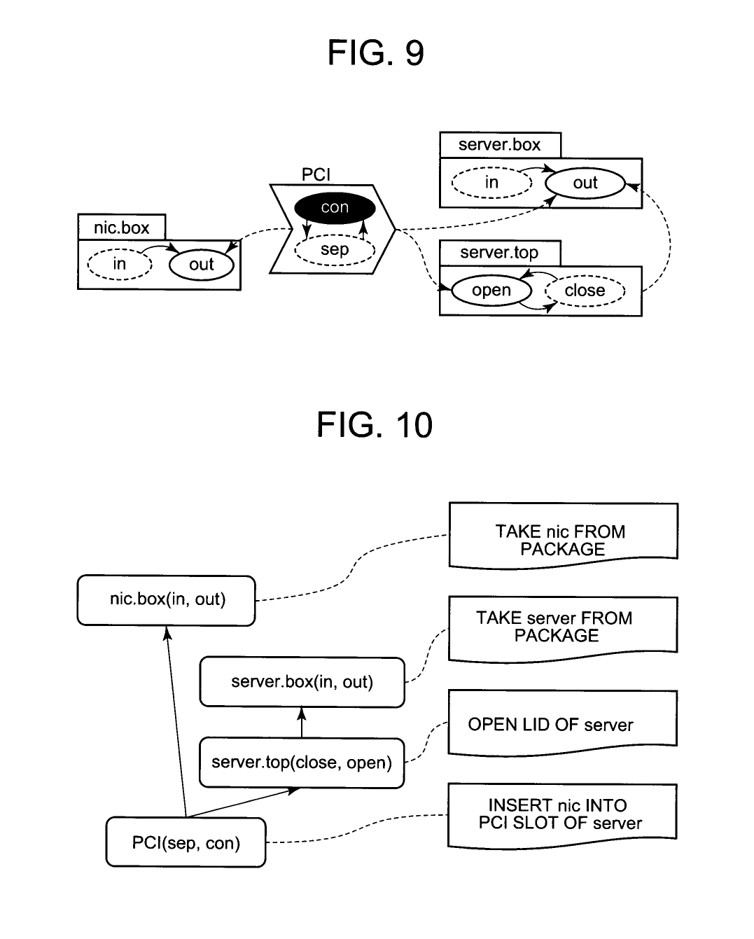

FIG. 9 is an explanatory diagram depicting an example of a state machine set expanded from connected primitives. FIG. 9 depicts a state machine set generated by expanding the system definition made up of the primitives and wiring depicted in FIG. 8.

Any unconnected wire port and any transition condition relating to the unconnected wire port are removed upon expanding the system definition. All parts are transferred to the expansion result as state machines. Upon the transfer, each state machine is assigned a unique ID, for example, a character string in which the ID of the expansion source primitive and the name of the part are linked by “.”.

The wiring and the wire ports at both ends connected via the wiring are transferred to the expansion result as one state machine. All transition conditions associated with the wire ports at both ends are transferred to the state machine. In other words, a transition condition from a part to a wire port and a transition condition from a wire port to a part are deleted, and instead a transition condition from a part to the state machine derived from the wire ports and the wiring and a transition condition from the state machine derived from the wire ports and the wiring to a part are generated.

The current state and the desired state designated in each part are transferred to the current state and the desired state of the state machine derived from the part. In this exemplary embodiment, the current state and the desired state of the state machine derived from the wire ports and the wiring are always set to “separate” and “connect”, respectively. The transition and the system change task of the state machine derived from the wire ports and the wiring are set to the transition and the system change task defined in the wire interface of the wire ports.

FIG. 10 is an explanatory diagram depicting an example of a system change plan generation result. FIG. 10 depicts an example of tasks obtained through computation based on the state machine set depicted in FIG. 9. As depicted in FIG. 10, the executable system change tasks are generated on the basis of the definitions of the primitives and the definitions of the primitive connection described above.

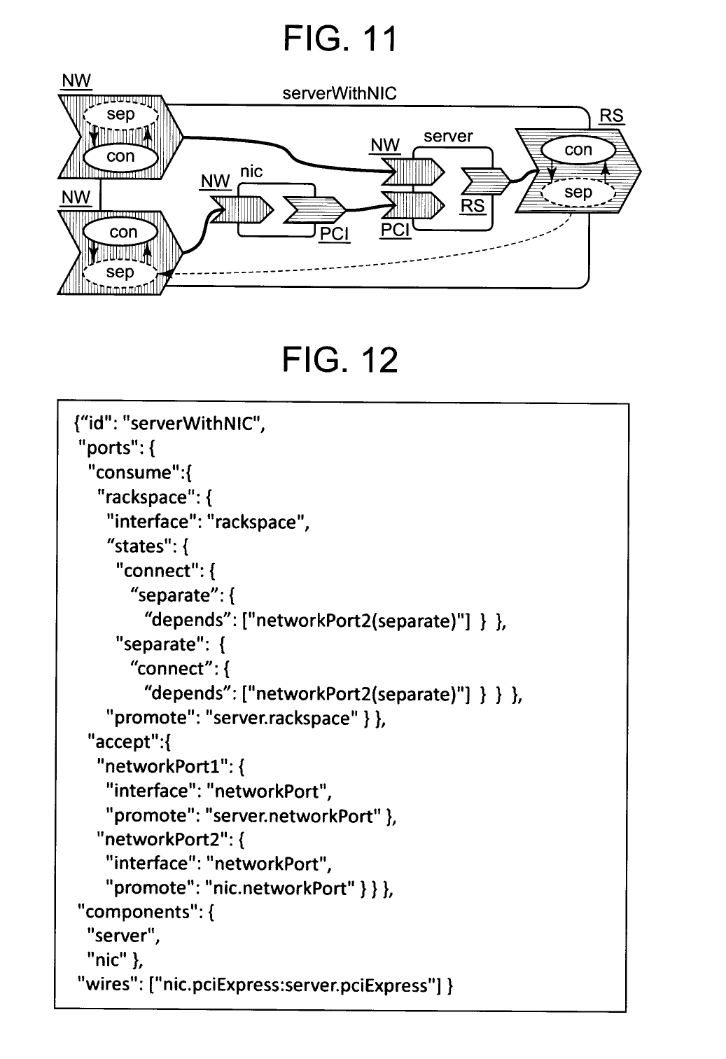

The following describes a composite which is the other type of component. FIG. 11 is an explanatory diagram depicting an example of a composite. FIG. 11 depicts “serverWithNIC” which is an example of a composite for treating the combined structure of “server” and “nic” mentioned above as one component.

The composite is mainly made up of internal components and wire ports. Each wire port of the composite references a wire port of any of the internal components of the composite. In other words, the wire port of the composite is connected to the wire port of the internal component of the composite as the reference destination. The concept of this connection is referred to as “promote” in this exemplary embodiment.

The promote destination wire port needs to have the same wire interface as the promote source wire port. Hence, an accept is promoted to an accept, and a consume is promoted to a consume.

Any transition condition is defined between state machines in the wire ports of the composite and the internal components of the composite.

When expanding the system definition, the system definition expansion unit 101 removes the definition of the composite itself from the system definition, and instead adds the definitions of the internal components to the system definition. For example, the system definition expansion unit 101 re-associates a wiring and a transition condition, which are associated with a wire port of the composite, with a wire port of an internal component of the composite to which the wire port is promoted. Thus, the definition of the composite is converted to the definition of each internal component of the composite.

In the case of “serverWithNIC” depicted in FIG. 11, one consume conforming to “RS” and two accepts conforming to “NW” are defined as wire ports. Both “RS” and “NW” are wire interfaces, as depicted in FIG. 11.

As depicted in FIG. 11, the two primitives “nic” and “server” are defined as the internal components of the composite. Here, “nic” and “server” are connected by a wiring via wire ports conforming to the wire interface “PCI”.

The upper accept conforming to “NW” in “serverWithNIC” is promoted to the accept conforming to “NW” in “server”. The lower accept conforming to “NW” is promoted to the accept conforming to “NW” in “nic”.

The consume conforming to “RS” in “serverWithNIC” is promoted to the consume conforming to “RS” in “server”. The consume conforming to “RS” in “serverWithNIC” defines a transition condition with respect to the state “sep” of the lower accept conforming to “NW”.

Upon expansion, the wiring and the transition condition associated with each wire port of the composite are all transferred to the promote destination wire port. In the example depicted in FIG. 11, the same transition conditions as the transition conditions of the wire ports in “serverWithNIC” conforming to the respective wire interfaces “RS” and “NW” are transferred to between the consume conforming to “RS” in “server” and the accept conforming to “NW” in “nic”. The transition condition of the wire port conforming to “RS” corresponds to the transferred transition condition.

FIG. 12 is an explanatory diagram depicting an example of a textual definition of a composite. FIG. 12 depicts an example of textually defining “serverWithNIC” depicted in FIG. 11, as an example of representation using JSON.

The definition depicted in FIG. 12 has an id element indicating the ID of the composite, a ports element indicating each wire port, a components element indicating each internal component of the composite, and a wires element indicating the connection of the internal components of the composite

The structure of the ports element depicted in FIG. 12 is similar to the structure of the ports element in the definition of the primitive depicted in FIG. 6, but differs in that a promote element indicating a promote is included. The component element defines a list of the IDs of the internal components. The wires element defines a list of wirings made up of the reference destination wire ports of the two internal components.

In the example depicted in FIG. 12, “server” and “nic” are defined in the components element, “rackspace” is defined in the consume element, and “networkPort1” and “networkPort2” are defined in the accept element.

Meanwhile, “rackspace” is defined in the wire interface of “rackspace”. This definition corresponds to the consume conforming to the wire interface “RS” depicted in FIG. 11. Moreover, “networkPort1” and “networkPort2” correspond to the respective two accepts conforming to the wire interface “NW” depicted in FIG. 11.

Further, “server.rackspace” is defined in the promote element of “rackspace”. This definition indicates that “rackspace” is promoted to the wire port “rackspace” of the internal component “server”. Likewise, “server.networkPort” is defined in the promote element of “networkPort1”, and “nic.networkPort” is defined in the promote element of “networkPort2”.

Besides, “nic.pciExpress:server.pciExpress” is defined in the wires element. This definition indicates that the wire port “pciExpress” of the internal component “nic” and the wire port “pciExpress” of the internal component “server” are connected by a wiring.

The system definition depicted in FIG. 8 is described in the same way as the definition depicted in FIG. 12, as a composite with no wire port.

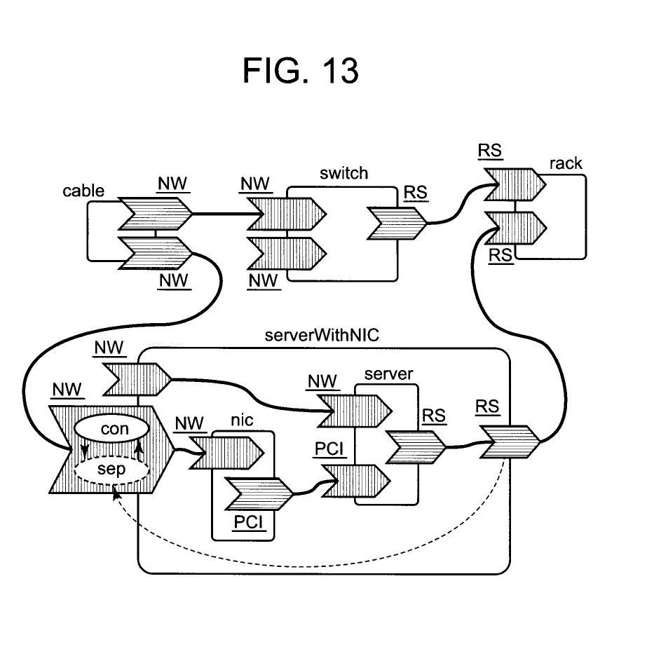

The definition method described above defines a system formed by combining a plurality of primitives and composites. FIG. 13 is an explanatory diagram depicting an example of a system definition made up of primitives and a composite. The states that need not be particularly depicted are omitted in FIG. 13.

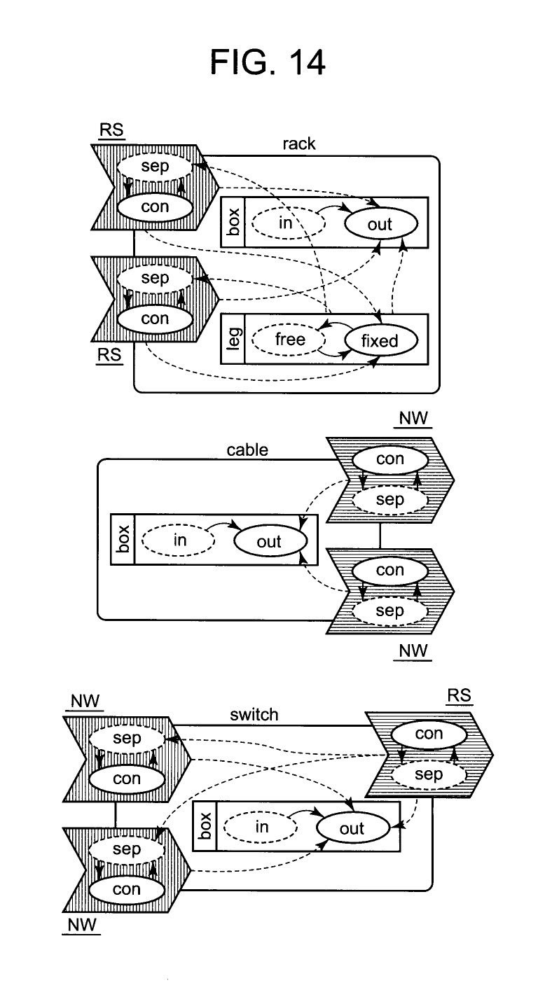

FIG. 13 depicts an example of a system definition of a computer stack made up of the above-mentioned “serverWithNIC” and three primitives “cable”, “switch”, and “rack”. FIG. 14 depicts the definitions of “cable”, “switch”, and “rack”. FIG. 14 is an explanatory diagram depicting another example of primitives.

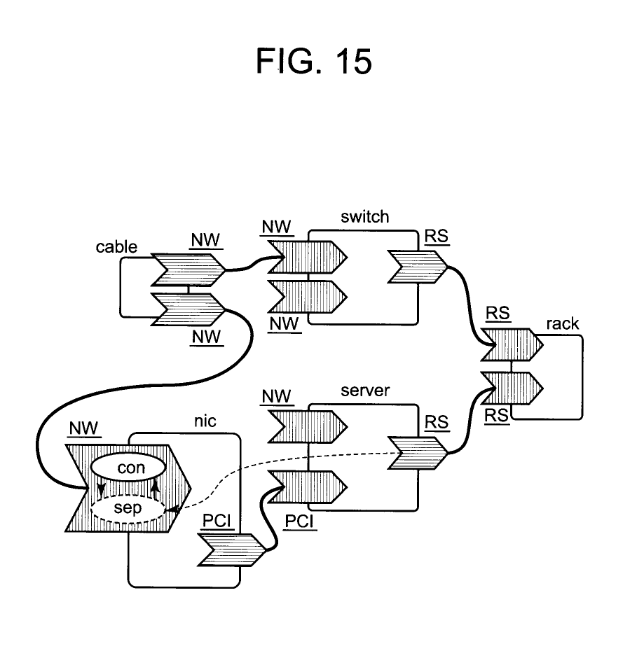

FIG. 15 is an explanatory diagram depicting an example of primitives expanded from a composite. FIG. 15 depicts a situation where the composite depicted in FIG. 13 is expanded into primitives.

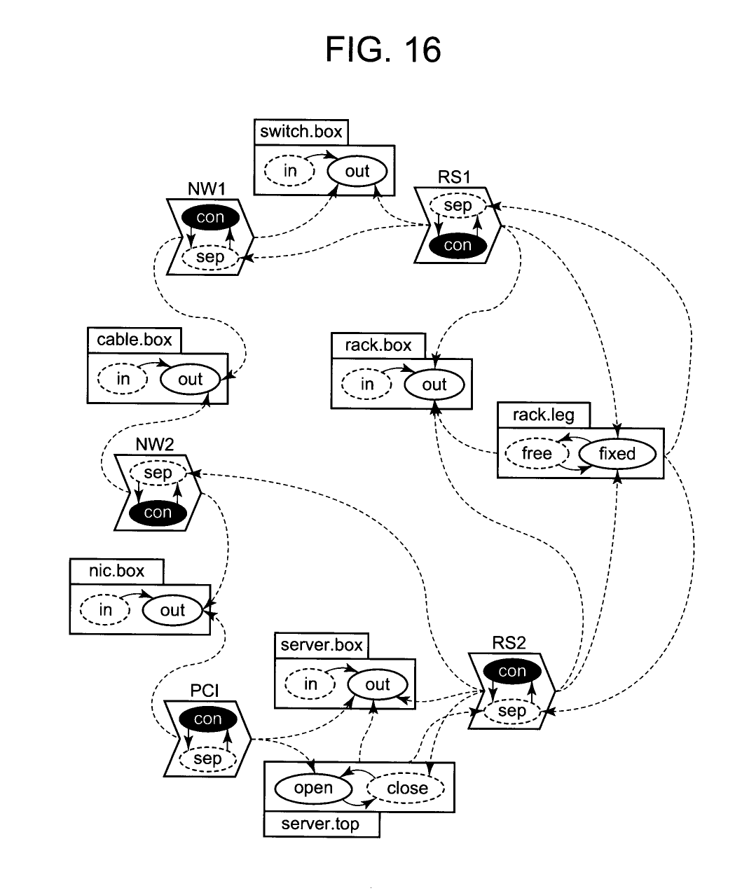

FIG. 16 is an explanatory diagram depicting an example of a state machine set of a system definition expanded from primitives. FIG. 16 depicts a situation where the primitives depicted in FIG. 15 are further expanded into a state machine set.

When the system is defined in this exemplary embodiment, already defined components are reused as the internal components of the composite. In the example depicted in FIG. 13, the four definitions “serverWithNIC”, “cable”, “switch”, and “rack” are reused. By simply connecting the definitions using wirings, a state machine set made up of 12 state machines and complex transition conditions between the state machines as depicted in FIG. 16 is defined easily.

The system definition expansion unit 101 in this exemplary embodiment is, for example, realized by a central processing unit (CPU) executing processes according to control of a program stored in a non-transitory computer-readable recording medium.

[Operation]

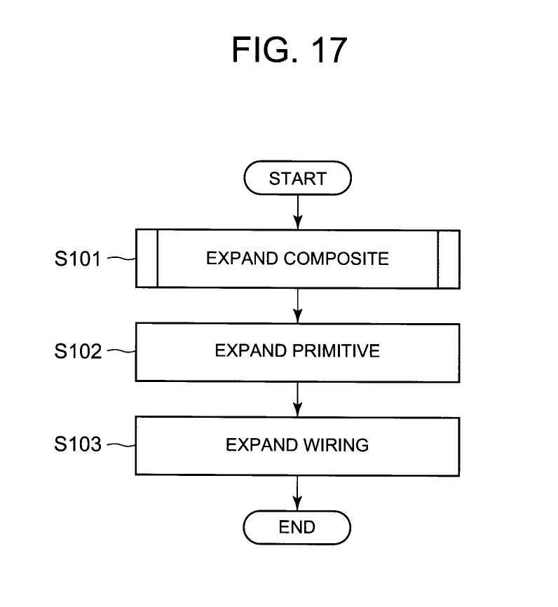

The following describes the operation of the change management system 100 in this exemplary embodiment, with reference to FIG. 17. FIG. 17 is a flowchart depicting operation of a system definition expansion process by the change management system 100.

The system definition expansion unit 101 receives information of a system definition from the input/output unit 201. The system definition expansion unit 101 regards a system based on the received information, as a composite. The system definition expansion unit 101 accordingly performs a process of recursively resolving the composite into primitives and wirings (step S101).

As a result of the process in step S101, a composite included in the system and a composite included in the composite are all resolved into primitives and wirings.

The system definition expansion unit 101 then copies state machines in all parts in all primitives, to information of a state machine set as an output result (step S102).

The system definition expansion unit 101 then copies state machines in all wirings to the information of the state machine set as the output result. Upon copying, the system definition expansion unit 101 removes information of transition conditions with respect to wire ports at both ends of each wiring and transition conditions of the wire ports.

After the removal, the system definition expansion unit 101 re-defines the same transition conditions as the removed transition conditions, for a state machine derived from the wiring (step S103). After expanding the wiring, the system definition expansion unit 101 ends the process.

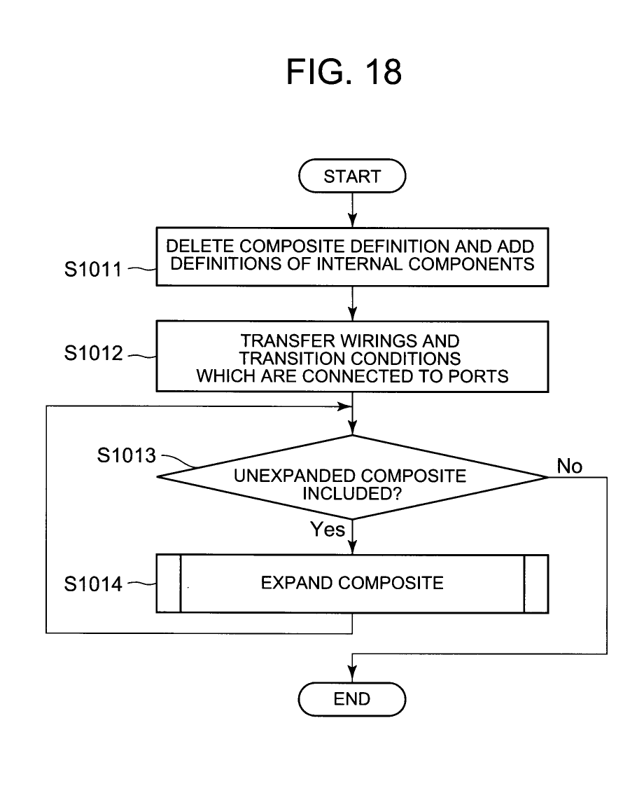

The following describes the detailed process in step S101, with reference to FIG. 18. FIG. 18 is a flowchart depicting operation of a composite expansion process by the change management system 100.

Upon receiving the composite, the system definition expansion unit 101 removes the definition of the composite from the system definition which is the basis of the composite. After the removal, the system definition expansion unit 101 adds the definitions of the internal components of the composite in place of the definition of the composite (step S1011).

Following this, the system definition expansion unit 101 transfers all wirings and transition conditions associated with all wire ports included in the composite, to the wire ports of the internal components connected by the wire ports via promotes (step S1012).

In detail, the definitions of the original wirings and transition conditions are converted in the transfer in step S1012. For example, converting a definition is to change a wire port portion of the composite in the definition to a wire port of an internal component as a transfer destination.

In the example of expanding the system definition depicted in FIG. 13 into the primitives depicted in FIG. 15, the wiring having “RS” as a wire interface and connecting “rack” and “serverWithNIC” is converted to the wiring connecting “rack” and “server”.

In more detail, the description “serverWithNIC.rackspace1:rack.rackspace2” in the definition of the wiring in the system definition is changed to, for example, the description “server.rackspace:rack.rackspace2”.

Likewise, the transition condition of the consume “rackspace” of “serverWithNIC” to “serverWithNIC.networkPort2(separate)” is added to the consume “rackspace” of “server”, as the transition condition to “nic.networkPort(separate)”.

Next, if any composite is included in the internal components of the composite, the system definition expansion unit 101 acquires each composite. The system definition expansion unit 101 repeats the expansion process on each acquired composite.

The system definition expansion unit 101 determines whether or not any composite is included in the internal components of the composite (step S1013). In the case where no composite is included (step S1013: No), the system definition expansion unit 101 ends the process.

In the case where a composite is included (step S1013: Yes), the system definition expansion unit 101 acquires the composite, and repeats the expansion process (step S1014). After expanding the composite, the system definition expansion unit 101 performs the process in step S1013 again.

### Advantageous Effects

The change management system in this exemplary embodiment can efficiently describe a state machine set by combining component information while reusing predefined component information.

### Exemplary Embodiment 2

[Structure]

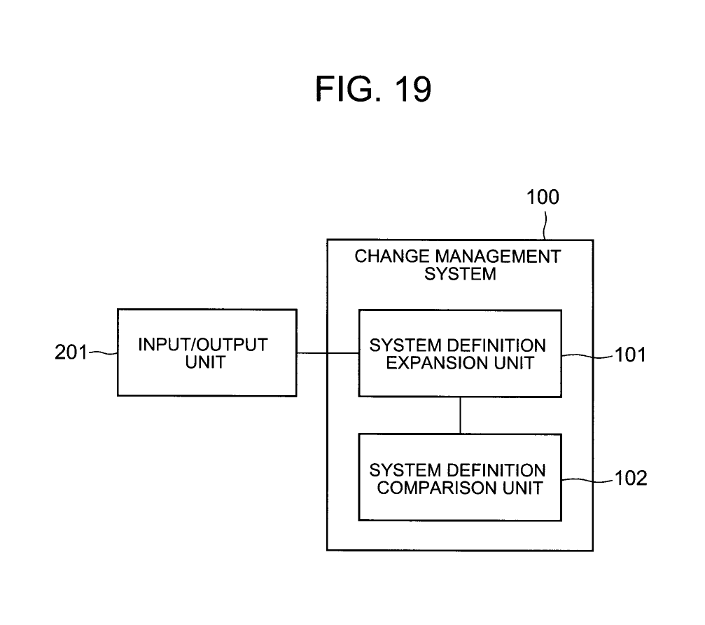

The following describes Exemplary Embodiment 2 of the present invention, with reference to drawings. FIG. 19 is a block diagram depicting a structural example of Exemplary Embodiment 2 of a change management system according to the present invention. In FIG. 19, the same structural elements as those in Exemplary Embodiment 1 are given the same reference signs, and their description is omitted.

The change management system 100 in this exemplary embodiment includes a system definition comparison unit 102 in addition to the system definition expansion unit 101, as depicted in FIG. 19. The system definition comparison unit 102 has a function of generating a system difference definition from two definitions that are a current system definition and a new system definition. The system definition expansion unit 101 is connected to the system definition comparison unit 102 via a communication network or the like so as to communicate with the system definition comparison unit 102.

The system definition expansion unit 101 in this exemplary embodiment receives information of two state machine sets that are an old (current) and new state machine sets, from the input/output unit 201. The system definition expansion unit 101 feeds the received information to the system definition comparison unit 102.

The system definition comparison unit 102 compares the received two state machine sets, and generates a system difference definition. The system definition comparison unit 102 returns the generated system difference definition to the system definition expansion unit 101.

The system definition expansion unit 101 then generates a state machine set based on the system difference definition. The system definition expansion unit 101 returns the generated state machine set to the input/output unit 201.

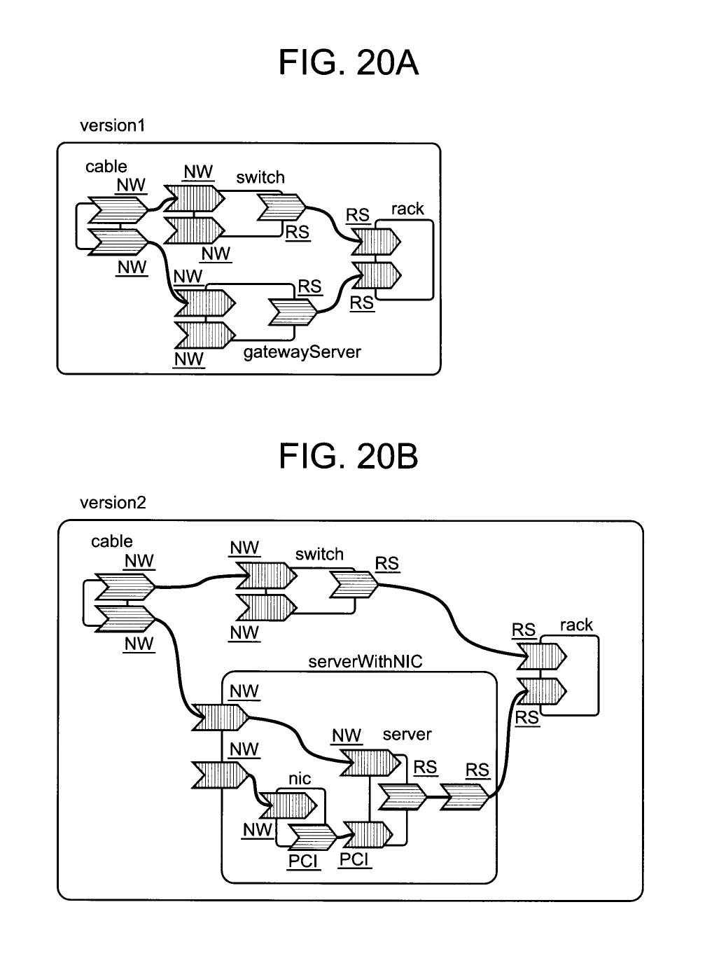

FIG. 20A and FIG. 20B are explanatory diagrams depicting examples of system definitions of two different versions. A system definition designated as version1 in FIG. 20A is a current system definition. A system definition designated as version2 in FIG. 20B is a new system definition.

The difference between the two system definitions lies in that the primitive “gatewayServer” in the current system definition in FIG. 20A is changed to the composite “serverWithNIC” in the new system definition in FIG. 20B.

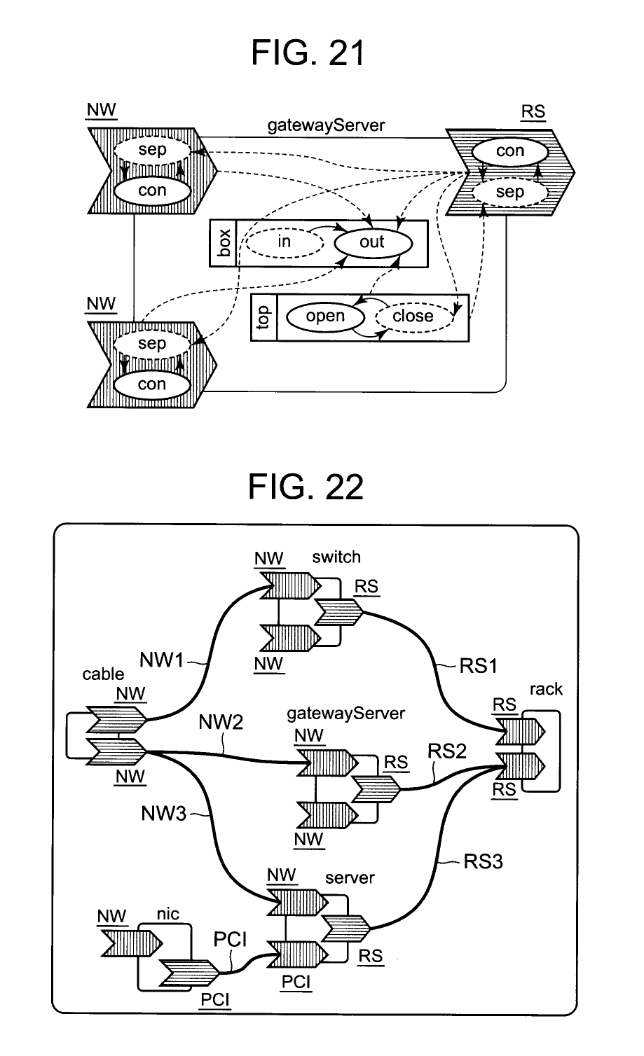

In detail, a system change task of removing “gatewayServer” from the system and then incorporating “serverWithNIC” into the system is added to the system change plan. Here, “gatewayServer” has a structure depicted in FIG. 21, as an example. FIG. 21 is an explanatory diagram depicting another example of primitives.

In this exemplary embodiment, each part in each primitive in the input system definitions has only a current state. Even in the new system definition, the primitive has a desired state as a current state. Note here that each part in each primitive has an initial state without exception. For example, the initial state is set on the basis of an initial state when the primitive is shipped from the seller.

FIG. 22 is an explanatory diagram depicting an example of the system difference definition generated from the two system definitions depicted in FIG. 20A and FIG. 20B. All composites included in the original system definitions have been expanded into primitives in the system difference definition.

The system difference definition depicted in FIG. 22 includes six primitives “cable”, “switch”, “rack”, “gatewayServer”, “nic”, and “server”. Of the six primitives, the three primitives “cable”, “switch”, and “rack” are included in both of the current and new system definitions. The three primitives themselves are accordingly marked as primitives maintained in the system difference definition. The state of each part in the three primitives is updated according to need.

The primitive “gatewayServer” is included in only the current system definition. The primitive “gatewayServer” is therefore marked as an abandoned primitive. The primitives “nic” and “server” are included in only the new system definition. The primitives “nic” and “server” are therefore marked as primitives newly added to the system difference definition.

A wiring connecting maintained primitives is marked as a maintained wiring. The wirings designated as “NW1” and “RS1” in FIG. 22 are the maintained wirings.

A wiring connecting a maintained primitive and an abandoned primitive is marked as a removed wiring. The wirings designated as “NW2” and “RS2” in FIG. 22 are the removed wirings.

A wiring connecting a maintained primitive and an added primitive or a wiring connecting added primitives is marked as a newly set wiring. The wirings designated as “NW3”, “RS3”, and “PCI” in FIG. 22 are the newly set wirings.

A wiring connecting abandoned primitives may be removed or maintained.

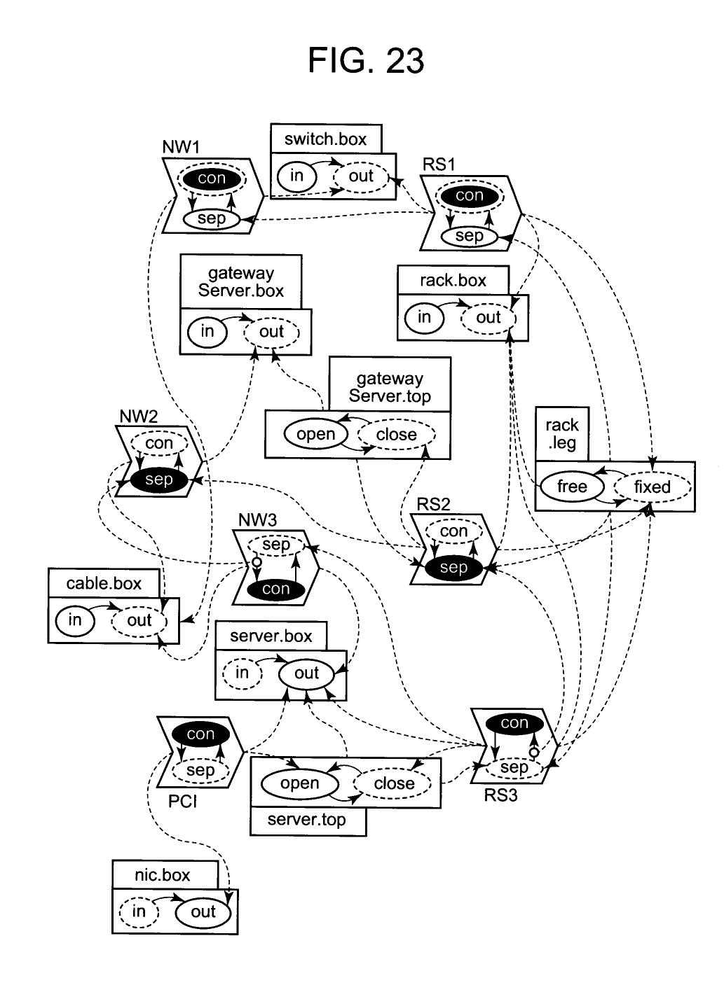

FIG. 23 is an explanatory diagram depicting an example of a state machine set expanded from a system difference definition. FIG. 23 depicts an example of the state machine set generated by expanding the system difference definition depicted in FIG. 22. The method of expanding primitives and wirings into state machines in this exemplary embodiment is basically the same as the expansion method in Exemplary Embodiment 1.

The expansion method in this exemplary embodiment, however, differs from the method in Exemplary Embodiment 1 in that the current state and the desired state are reset according to the current and new system definitions. The expansion method in this exemplary embodiment also differs from the method in Exemplary Embodiment 1 in that, in the case where a current wiring and a new wiring are connected to the same wire port, a transition condition is added so that a transition for connecting one wiring has a transition condition that the other wiring is disconnected.

A part in a maintained or updated primitive includes the current state of the part in the current system definition as the current state, and the current state of the part in the new system definition as the desired state.

A part in an abandoned primitive includes the current state of the part in the current system definition as the current state. The desired state of the part in the abandoned primitive may be any state, and so need not be set.

A part in an added primitive includes the initial state of the part as the current state, and the current state of the part in the new system definition as the desired state.

A maintained wiring includes both the current state and the desired state as the connected state. A removed wiring includes the current state as the connected state, and the desired state as the disconnected state. A newly connected wiring includes the current state as the disconnected state, and the desired state as the connected state.

There is no wiring connecting abandoned primitives in the example depicted in FIG. 23. In the case where there is a wiring connecting abandoned primitives, the wiring has the current state as the connected state, and has no desired state.

In the example depicted in FIG. 23, only a transition condition from a new wiring to a current wiring is added as a transition condition to a wiring which is a transition condition affecting the transition order computation result. The transition condition from the transition “NW3(sep, con)” to “NW2(sep)” and the transition condition from the transition “RS3(sep, con)” to “RS2(sep)” depicted in FIG. 23 are the added transition conditions.

[Operation]

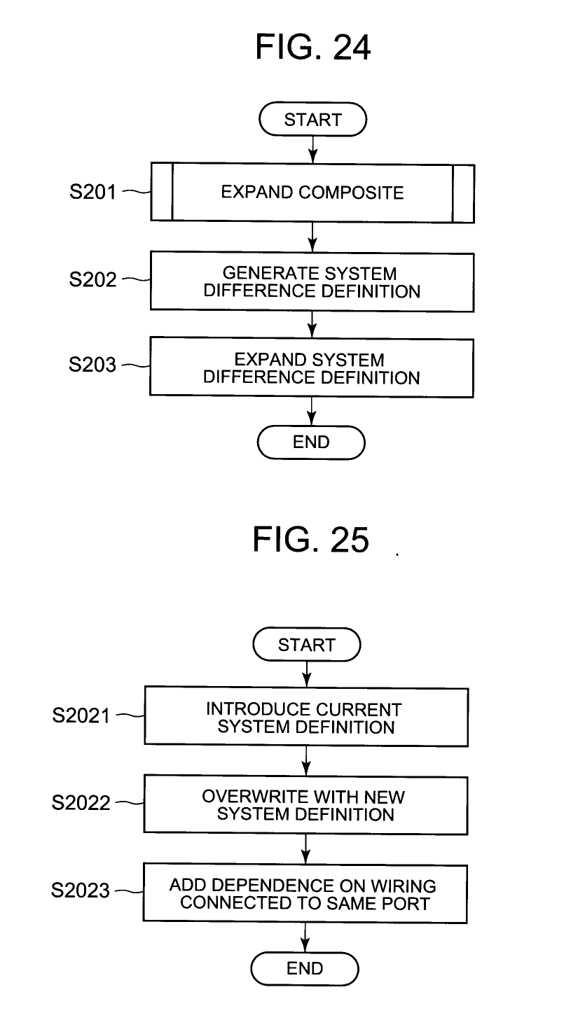

The following describes the operation of the change management system 100 in this exemplary embodiment, with reference to FIG. 24. FIG. 24 is a flowchart depicting operation of a system difference definition generation process and expansion process by the change management system 100.

The system definition expansion unit 101 in this exemplary embodiment receives information of system definitions of two current and new versions from the input/output unit 201. The system definition expansion unit 101 regards a system based on the received information, as a composite. The system definition expansion unit 101 resolves each composite into primitives and wirings (step S201).

The system definition expansion unit 101 feeds each system definition expanded into only primitives and wirings, to the system definition comparison unit 102. The detailed process in step S201 is the same as the process in step S101 in Exemplary Embodiment 1.

The system definition comparison unit 102 generates a system difference definition from the received two system definitions (step S202). The system definition comparison unit 102 returns the generated system difference definition to the system definition expansion unit 101.

The system definition expansion unit 101 then expands the system difference definition received from the system definition comparison unit 102, to generate a state machine set(step S203). The system definition expansion unit 101 returns the generated state machine set to the input/output unit 201. After returning the state machine set, the system definition expansion unit 101 ends the process.

The following describes the detailed process in step S202, with reference to FIG. 25. FIG. 25 is a flowchart depicting operation of a system difference definition generation process by the change management system 100.

The system definition comparison unit 102 copies the current system definition to a provisional system difference definition. After copying the current system definition, the system definition comparison unit 102 performs recording to abandon all primitives in the current system definition (step S2021). The recording may be performed by, for example, adding one primitiveState element to the data depicted in FIG. 6 and setting the value of the added primitiveState element to “old”.

The system definition comparison unit 102 then acquires one primitive and one wiring in the new system definition. The system definition comparison unit 102 writes the acquired information over the corresponding information in the provisional system difference definition (step S2022).

The system definition comparison unit 102 determines whether or not a primitive having the same ID is included in the provisional system difference definition. In the case where a primitive having the same ID is included, the system definition comparison unit 102 performs recording to maintain the primitive in the provisional system difference definition. In the case where no primitive having the same ID is included, the system definition comparison unit 102 adds the primitive to the provisional system difference definition, and performs recording to add the primitive to the elements in the primitive definition.

The recording to maintain the primitive may be performed by, for example, changing the value of the primitiveState element to “update”. The recording to add the primitive may be performed by, for example, changing the value of the primitiveState element to “new”.

In the case where a primitive having the same ID is included in the provisional system difference definition, the system definition comparison unit 102 sets the desired state of each part in the primitive, to the current state of the corresponding part in the new primitive.

In the case where no primitive having the same ID is included in the provisional system difference definition, the system definition comparison unit 102 sets the desired state of each part in the added primitive to the current state of the part, and sets the current state of each part in the added primitive to the initial state of the part.

The system definition comparison unit 102 simply adds the wiring to the system difference definition.

Consider the case where the wiring is implemented as an object in a program. In such a case, the system definition comparison unit 102 updates the reference relationship so that, after step S2022, not the wire ports included in the primitive in the new system definition but the wire ports included in the primitive in the provisional system difference definition are referenced as the wire ports at both ends of the wiring.

Following this, the system definition comparison unit 102 references each wire port in all primitives. If a wire port associated with both a current wiring and a new wiring is found as a result of the referencing, the system definition comparison unit 102 adds a transition condition relating to the new wiring of the two associated wirings (step S2023). The added transition condition is a transition condition that the current wiring is in the disconnected state, for a transition of changing the new wiring from the disconnected state to the connected state. After adding the transition condition, the system definition comparison unit 102 ends the process.

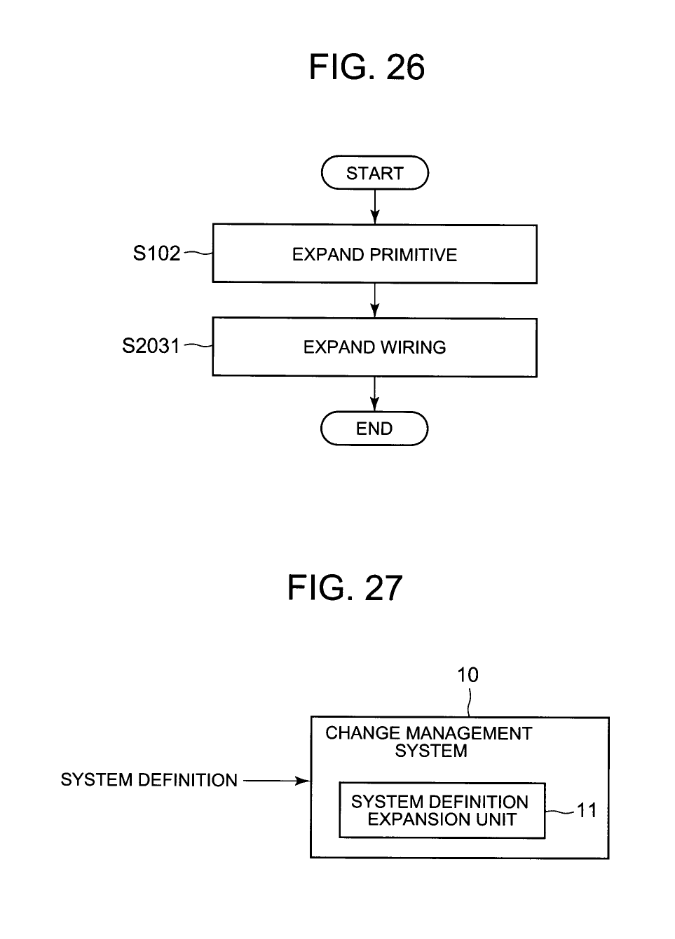

The following describes the detailed process in step S203, with reference to FIG. 26. FIG. 26 is a flowchart depicting operation of a system difference definition expansion process by the change management system 100.

Upon receiving the system difference definition from the system definition comparison unit 102, the system definition expansion unit 101 copies state machines in all parts in all primitives of the system difference definition, to information of a state machine set as an output result (step S102).

The system definition expansion unit 101 then copies state machines in all wirings, to the information of the state machine set as the output result. Upon copying, the system definition expansion unit 101 removes information of transition conditions with respect to wire ports at both ends of each wiring and transition conditions of the wire ports.

After the removal, the system definition expansion unit 101 re-defines the same transition conditions as the removed transition conditions, for a state machine derived from the wiring. Having re-defined the transition conditions, the system definition expansion unit 101 checks the primitiveState elements of the primitives including the wire ports at both ends of the wiring.

The system definition expansion unit 101 sets the current state and the desired state of the state machine derived from the wiring having maintained or updated primitives at both ends, both to the connected state.

The system definition expansion unit 101 sets the current state and the desired state of the state machine derived from the wiring having an abandoned primitive at at least one end, respectively to the connected state and the disconnected state.

The system definition expansion unit 101 sets the current state and the desired state of the state machine derived from the wiring having an added primitive at at least one end, respectively to the disconnected state and the connected state (step S2031). After expanding the wiring, the system definition expansion unit 101 ends the process.

### Advantageous Effects

The change management system in this exemplary embodiment describes a state machine set more intuitively and efficiently, from input of a new system definition obtained by editing the current system definition.

The following describes the overview of the present invention. FIG. 27 is a block diagram schematically depicting a change management system according to the present invention. A change management system 10 according to the present invention includes a system definition expansion unit 11 (e.g. the system definition expansion unit 101) which generates information of a state machine set made up of one or more state machines, from a system definition, wherein the system definition includes one or more primitives and any number of wirings, wherein each of the primitives includes any number of wire ports, wherein each of the wire ports includes one state machine, wherein each of the wirings connects to two wire ports included in different primitives, and wherein the system definition expansion unit 11 generates the information of the state machine set, by connecting existing definitions of the primitives by the wirings.

With such a structure, the change management system can efficiently describe a number of state machine sets from a system definition including state machines.

Moreover, a state in the state machine included in the wire port may transition to another state according to a transition condition relating to a state in a state machine included in another wire port included in a primitive that includes the wire port, and the system definition expansion unit 11 may generate the information of the state machine set so that state machines derived from each of all wirings in the system definition is included and that a transition condition associated with a wire port is re-associated with a state machine derived from a wiring connecting to the wire port.

With such a structure, the change management system can transfer a transition condition to a relevant state machine.

Moreover, each of the primitives may include any number of parts, each of the parts may include one state machine, a state in a state machine included in the primitive may transition to another state according to a transition condition relating to a state in a state machine included in another part or wire port included in the primitive, and the system definition expansion unit 11 may generate the information of the state machine set so that state machines derived from each of all parts included in all primitives in the system definition and transition conditions between all parts are included.

With such a structure, the change management system can expand a system definition including a part.

Moreover, the system definition may include one or more composites, each of the composites may include one or more primitives or composites, any number of wire ports, any number of wirings, and any number of promotes, each of the wirings may connect to two wire ports included in different primitives or composites included in the composite, each of the promotes may connect a wire port included in the composite and a wire port included in a primitive or a composite included in the composite, a state in any state machine included in any of a wire port, a composite, and a primitive included in the composite may transition to another state according to a transition condition relating to a state in another state machine, and the system definition expansion unit 11 may transfer a transition condition associated with a wiring connected to a wire port in the composite, to a wire port in the composite connected with the wire port by a promote.

With such a structure, the change management system can expand a system definition including a composite.

Moreover, the change management system 10 may include a system definition comparison unit (e.g. the system definition comparison unit 102) which generates, from two system definitions of a current system definition and a new system definition, a system difference definition that includes all primitives and wirings included in any of the two system definitions without an overlap.

With such a structure, the change management system can generate a system difference definition from two system definitions.

Moreover, the system definition comparison unit may: determine a primitive included in the two system definitions of the current system definition and the new system definition, as a maintained or updated primitive; determine a primitive included in only the current system definition, as an abandoned primitive; determine a primitive included in only the new system definition, as an added primitive; determine a wiring connecting maintained or updated primitives, as a maintained or updated wiring; determine a wiring connecting at least one abandoned primitive, as an abandoned wiring; and determine a wiring connecting to at least one added primitive, as an added wiring.

With such a structure, the change management system can determine a maintained or changed primitive and wiring from two system definitions.

Moreover, from the system difference definition, the system definition expansion unit 11 may: generate, from a part in a maintained or updated primitive, a state machine that includes a state of the part in the current system definition as a current state, and a state of the part in the new system definition as a desired state; generate, from a part in an abandoned primitive, a state machine that includes a state of the part in the current system definition as a current state; generate, from a part in an added primitive, a state machine that includes an initial state of the part as a current state, and a state of the part in the new system definition as a desired state; generate, from a maintained or updated wiring, a state machine that includes both a current state and a desired state as a connected state; generate, from an abandoned wiring, a state machine that includes a current state as a connected state and a desired state as a disconnected state; and generate, from an added wiring, a state machine that includes a current state as a disconnected state and a desired state as a connected state.

With such a structure, the change management system can generate a state machine set reflected the states of state machines in two system definitions.

Moreover, the system definition expansion unit 11 may add, to a transition of connecting a wiring, a transition condition that another wiring connected to the same wire port is disconnected.

With such a structure, the change management system can generate a state machine set from which proper operation order is determined, even in the case where two current and new wirings are connected to the same wire port.

To generate a change plan on the basis of the method described in NPL 1, it is necessary to describe a state machine set representing a system to be managed. Particularly in the case where a practical system made up of many components is to be managed, many state machines need to be described. Describing many state machines has a problem of an increase in person-hours for state machine description. NPL 1 does not specifically address the operation of describing state machines.

According to the present invention, information of a number of state machine sets can be efficiently generated from a system definition including state machines.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A change management system comprising
a system definition expansion unit which generates information of a state machine set made up of one or more state machines, from a system definition,
wherein the system definition includes one or more primitives and any number of wirings,
wherein each of the primitives includes any number of wire ports,
wherein each of the wire ports includes one state machine,
wherein each of the wirings connects to two wire ports included in different primitives, and
wherein the system definition expansion unit generates the information of the state machine set, by connecting existing definitions of the primitives by the wirings.

2. The change management system according to claim 1, wherein a state in the state machine included in the wire port transitions to another state according to a transition condition relating to a state in a state machine included in another wire port included in a primitive that includes the wire port, and
wherein the system definition expansion unit generates the information of the state machine set so that state machines derived from each of all wirings in the system definition is included and that a transition condition associated with a wire port is re-associated with a state machine derived from a wiring connecting to the wire port.

3. The change management system according to claim 1, wherein each of the primitives includes any number of parts,
wherein each of the parts includes one state machine,
wherein a state in a state machine included in the primitive transitions to another state according to a transition condition relating to a state in a state machine included in another part or wire port included in the primitive, and
wherein the system definition expansion unit generates the information of the state machine set so that state machines derived from each of all parts included in all primitives in the system definition and transition conditions between all parts are included.

4. The change management system according to claim 1, wherein the system definition includes one or more composites,
wherein each of the composites includes one or more primitives or composites, any number of wire ports, any number of wirings, and any number of promotes,
wherein each of the wirings connects to two wire ports included in different primitives or composites included in the composite,
wherein each of the promotes connects a wire port included in the composite and a wire port included in a primitive or a composite included in the composite,
wherein a state in any state machine included in any of a wire port, a composite, and a primitive included in the composite transitions to another state according to a transition condition relating to a state in another state machine, and
wherein the system definition expansion unit transfers a transition condition associated with a wiring connected to a wire port in the composite, to a wire port in the composite connected with the wire port by a promote.

5. The change management system according to claim 1, comprising
a system definition comparison unit which generates, from two system definitions of a current system definition and a new system definition, a system difference definition that includes all primitives and wirings included in any of the two system definitions without an overlap.

6. The change management system according to claim 5, wherein the system definition comparison unit: determines a primitive included in the two system definitions of the current system definition and the new system definition, as a maintained or updated primitive; determines a primitive included in only the current system definition, as an abandoned primitive; determines a primitive included in only the new system definition, as an added primitive; determines a wiring connecting maintained or updated primitives, as a maintained or updated wiring; determines a wiring connecting at least one abandoned primitive, as an abandoned wiring; and determines a wiring connecting to at least one added primitive, as an added wiring.

7. The change management system according to claim 6, wherein, from the system difference definition, the system definition expansion unit: generates, from a part in a maintained or updated primitive, a state machine that includes a state of the part in the current system definition as a current state, and a state of the part in the new system definition as a desired state; generates, from a part in an abandoned primitive, a state machine that includes a state of the part in the current system definition as a current state; generates, from a part in an added primitive, a state machine that includes an initial state of the part as a current state, and a state of the part in the new system definition as a desired state; generates, from a maintained or updated wiring, a state machine that includes both a current state and a desired state as a connected state; generates, from an abandoned wiring, a state machine that includes a current state as a connected state and a desired state as a disconnected state; and generates, from an added wiring, a state machine that includes a current state as a disconnected state and a desired state as a connected state.

8. The change management system according to claim 6, wherein the system definition expansion unit adds, to a transition of connecting a wiring, a transition condition that another wiring connected to the same wire port is disconnected.

9. A change management method executed in a change management system for generating, from a system definition, information of a state machine set made up of one or more state machines,
wherein the system definition includes one or more primitives and any number of wirings,
wherein each of the primitives includes any number of wire ports,
wherein each of the wire ports includes one state machine,
wherein each of the wirings connects to two wire ports included in different primitives, and
wherein the information of the state machine set is generated by connecting existing definitions of the primitives by the wirings.

10. A non-transitory computer-readable recording medium having recorded therein a change management program that, when executed by a computer, generates information of a state machine set made up of one or more state machines, from a system definition,
wherein the system definition includes one or more primitives and any number of wirings,
wherein each of the primitives includes any number of wire ports,
wherein each of the wire ports includes one state machine,
wherein each of the wirings connects to two wire ports included in different primitives, and
wherein the information of the state machine set is generated by connecting existing definitions of the primitives by the wirings.
